(19) United States
(12) Patent Application Publication
(10) Pub. No.: US 2010/0186529 A1
(43) Pub. Date: Jul. 29, 2010

(54) Linear actuator

(75) Inventors: Hsin-An Chiang, Taichung City (TW); Jin-Cheng Lin, Taichung City (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/321,874

(22) Filed: Jan. 27, 2009

(51) Int. Cl. F16H 25/20

(52) U.S. Cl. 74/89.37

(57) ABSTRACT

A linear actuator implements two contact switches for travel-limit control of an output shaft of the linear actuator and implements a variable resistor that is connected with a reduction gear of a motor of the linear actuator for providing a position feedback function.

### BACKGROUND OF THE INVENTION

1. Technical Field

The present invention relates to linear actuators, and more particularly, to a linear actuator that implements contacting limit switches to realize precise travel-limit control.

2. Description of Related Art

The conventional linear actuator typically has a motor to drive a screw that connects to an output shaft with a nut so that when the screw rotates, the nuts moves along the screw, thereby pushing or withdrawing a load in a linear travel path. Therein, reed switches are utilized to control limits of the linear travel path. To state simply, a permanent magnet is arranged on the output shaft while two reed switches are settled on a cylinder of the linear actuator and spaced from each other by a predetermined distance, so that when the permanent magnet is positioned far from the reed switches, contacts on the reed switches are disconnected and a circuit therebetween is opened or when the permanent magnet is near any one of the reed switches, contacts on the reed switch are connected and the circuit therebetween is closed to send an electrical signal to a controller, which controller thus controls the motor to stop operating.

As such a reed switch works on a non-contact switching mechanism, its accuracy tends to be affected by the magnetic field intensity of the magnet, the location of the magnet, and even the environmental magnetic fields and wrongly triggered, thereby causing undesired inaccuracy of the travel limits. Therefore, reed switches might not be a stable and reliable approach to travel-limit control for actuators.

### SUMMARY OF THE INVENTION

In view of the shortcomings of the prior arts, the primary objective of the present invention is to provide a linear actuator that implements contact switches as position sensors so as to define precise travel limits for the actuator, thereby improving the accuracy and reliability of travel-limit control.

Another objective of the present invention is to provide a linear actuator that serves to send its user feedback information about its current position so as to enhance use safety of the linear actuator.

The linear actuator of the present invent comprises two contacting limit switches to achieve travel-limit control of the actuator. By a variable resistor connected to a reduction gear in the motor of the actuator, the actuator enables a position feedback function to inform its user to of its current position, thereby enhancing use safety thereof.

### BRIEF DESCRIPTION OF THE DRAWINGS

The invention as well as a preferred mode of use, further objectives and advantages thereof will be best understood by reference to the following detailed description of illustrative embodiment when read in conjunction with the accompanying drawings, wherein:

FIG. 1 is a perspective view of an actuator according to the present invention;

FIG. 2 is an exploded view of the actuator according to the present invention, showing a motor, a connecting member, a protective tube, an output shaft, a positioning feedback device, a packing ring, a lead screw, a nut, a fixing bar, a first limit switch and a second limit switch;

FIG. 3 is another exploded view of the actuator according to the present invention, showing the stricture of the connecting member;

FIG. 4 is a lateral view of the actuator with a part thereof sectioned;

FIG. 5 shows the actuator detonating a limit switch at a maximum travel length thereof;

FIG. 6 shows the actuator detonating the limit switch at a minimum travel length thereof; and

FIG. 7 is a partial sectional view of the actuator taken along Line 7-7 of FIG. 1.

### DETAILED DESCRIPTION OF THE PREFERRED EMBODIMENTS

While a preferred embodiment is provided herein for illustrating the concept of the present invention as described above, it is to be understood that the components in these drawings are made for better explanation and need not to be made in scale. Moreover, in the following description, resemble components are indicated by the same numerals.

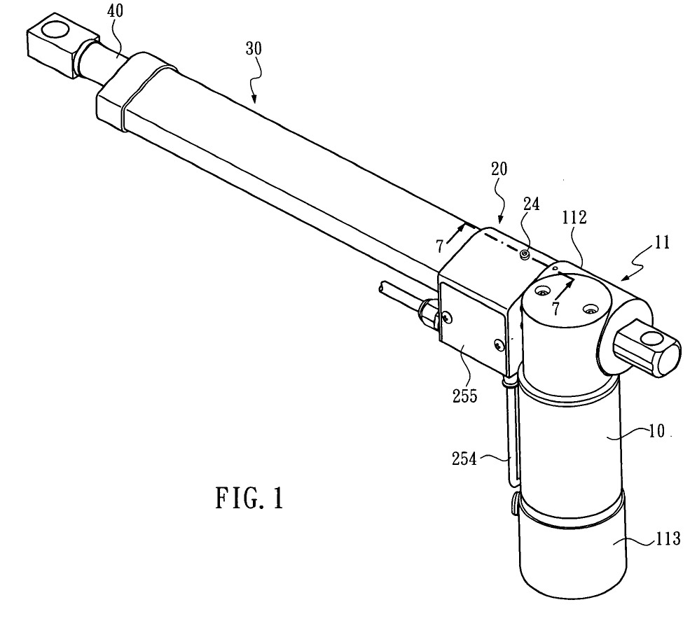

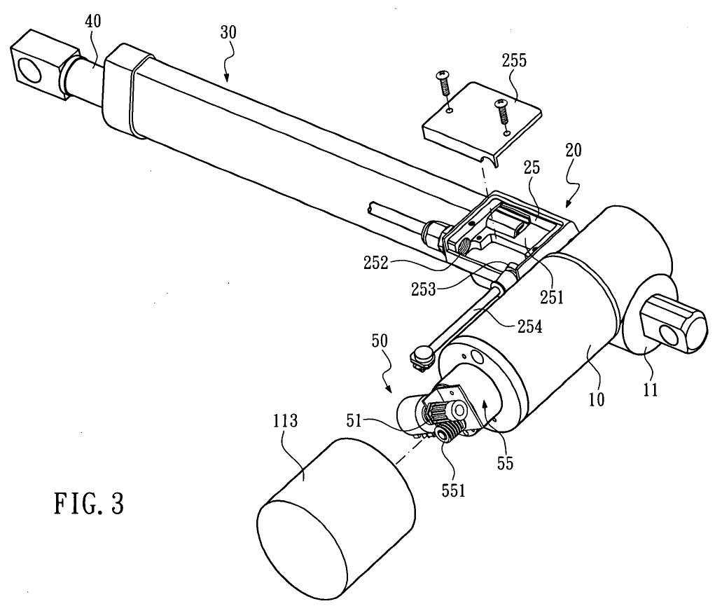

Referring to FIG. 1, a linear actuator of the present invention comprises a motor 10 that has a gearbox 11 outputting power from a driving shaft (not shown) of the motor 10. The gearbox 11 includes a housing 112 that is assembled with a connecting member 20. A protective tube 30 connected with the connecting member 20 is received therein an output shaft 40. A reduction gear 55 and a variable resistor 50 (shown in FIG. 3) are enclosed in a case 113 attached to the housing 112 of the motor 10.

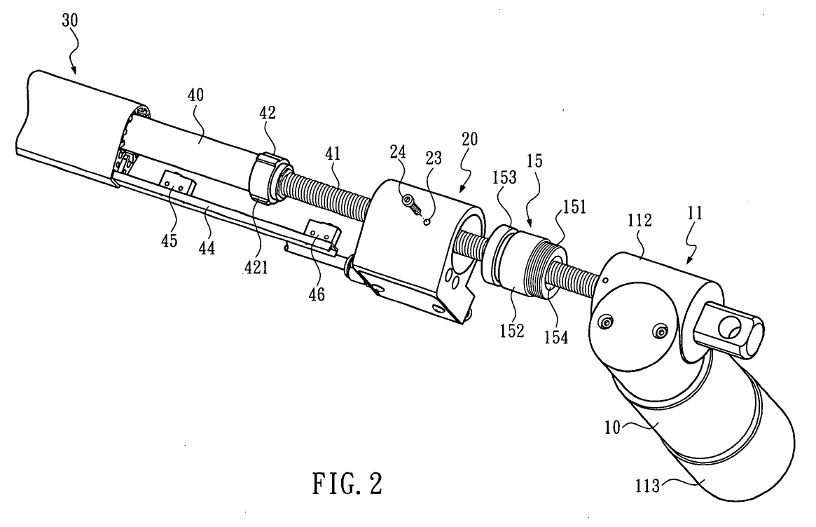

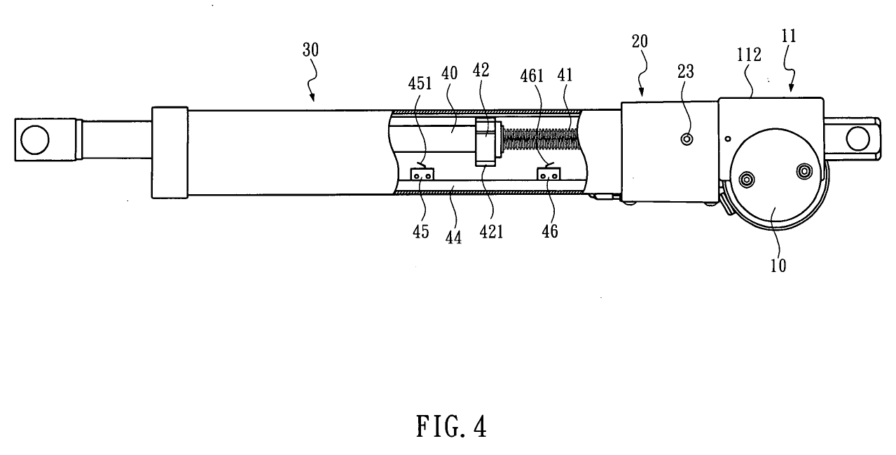

According to FIGS. 2 and 4, in addition to the motor 10, the connecting member 20, the protective tube 30 and the output shaft 40, the actuator further comprises a packing ring 15, a lead screw 41, a nut 42, a fixing bar 44, a first limit switch 45 and a second limit switch 46.

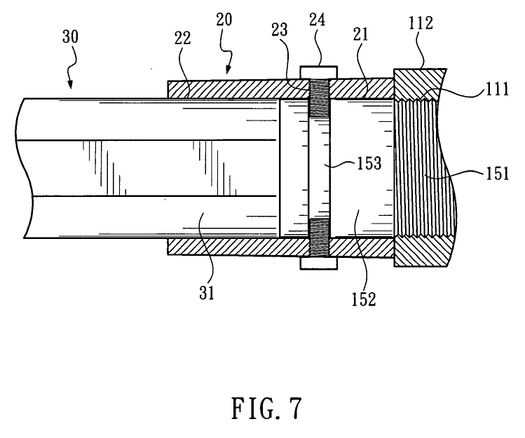

As can be seen in FIGS. 2 and 7, the packing ring 15 includes a combining portion 151, a packing portion 152, a fixing portion 153 and a central channel 154 axially passing through the packing ring 15. The combining portion 151 is formed with outer threads for being coupled with an inner threaded portion 111 on the housing 112 of the gearbox 11. A first receiving portion 21 is axially formed inside the connecting member 20 for receiving the packing portion 152 of the packing ring 15, and a second receiving portion 22 is also axially formed inside the connecting member 20 for receiving the protective tube 30, wherein the first receiving portion 21 and the second receiving portion 22 are intercommunicated mutually. The packing portion 152 of the packing ring 15 has its periphery in close fit with an inner wall of the first receiving portion 21. The fixing portion 153 is structurally a peripheral groove formed at an outer surface of the packing portion 152. The connecting member 20 is radially formed with at least one threaded hole 23 for allowing a flat-bottomed screw 24 to be screwed therein and pierce into the fixing portion 153 formed as the peripheral groove so as to press against a bottom of the fixing portion 153, thereby firmly combining the connecting member 20 and the packing ring 15. An end 31 of the protective tube 30 is also in close fit with the second receiving portion 22. One end of the lead screw 41 pierces into and gets positioned by the gearbox 11. A body of the lead screw 41 passes through the central channel 154 of the packing ring 15 and enters the protective tube 30. The nut 42 is screwedly engaged with the lead screw 41. The output shaft 40 has one end fixedly connected with the nut 42, a body passing through the protective tube 30, and an opposite end jutting out from the protective tube 30 to be fixedly connected with a load to be driven by the linear actuator. The fixing bar 44 is immovably settled inside the protective tube 30. The first limit switch 45 and the second limit switch 46 are deposited at predetermined locations on the fixing bar 44. A contacting portion 421 is raised from a surface of the nut 42 for touching triggers 451, 461 of the first limit switch 45 and the second limit switch 46.

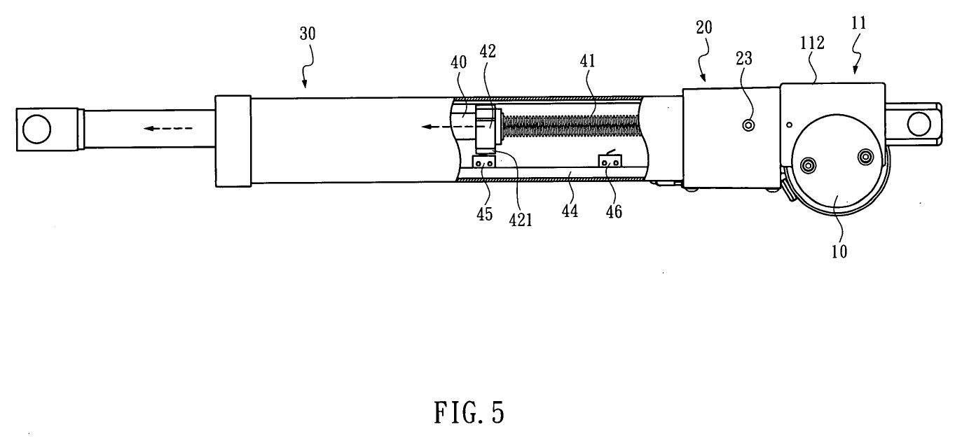

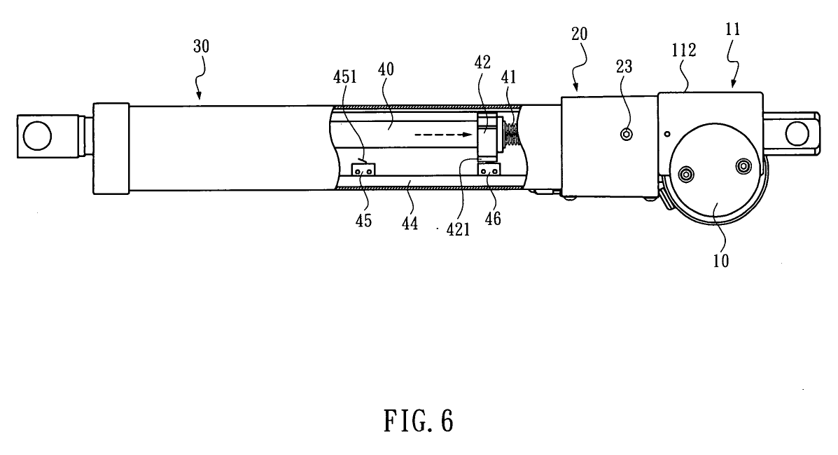

Referring to FIGS. 5 and 6, the motor 10 drives the lead screw 41 to move the nut 42 against the lead screw 41, thereby making the output shaft 40 move forward or backward. The travel limits in forward and backward directions are defined by the first limit switch 45 and the second limit switch 46, respectively. As shown in the drawing, when the output shaft 40 arrives at the travel limit in the forward direction, the contacting portion 421 of the nut 42 touches the touching trigger 451 of the first limit switch 45. When the output shaft 40 arrives at the travel limit in the backward direction, the contacting portion 421 of the nut 42 touches the touching trigger 461 of the second limit switch 46. Thereby, the implement of the contact switches eliminates the problem related to the traditional reed switches, so as to present improved stability and positioning accuracy.

Referring to FIG. 3, a wiring box 25 is affixed to a lateral of the connecting member 20 and detachably covered by a covering board 255. A wire outlet 251 is formed on the wiring box 25 for allowing wires from the limit switches to pass through while another two wire outlets 252, 253 are provided on the wiring box 25 for allowing wires of power cords and motor power-supplying wire to pass through, respectively. Thus, the wires of the first limit switch 45 and the second limit switch 46 are led into the wiring box 25 through the wire outlet 251. The power cords are led into the wiring box 25 through the wire outlet 252. The motor power-supplying wire is led into the wiring box 25 through the wire outlet 253. In the present embodiment, a wire tubing 254 is connected between the wire outlet 253 and a housing of the motor 10. Thereby, the first limit switch 45 and the second limit switch 46 are able to directly turn on or off the motor 10.

The reduction gear 55 and the variable resistor 50 attached to a rear of the motor 10. The reduction gear 55 implements a gear combination to retard the driving shaft of the motor 10. The reduction gear 55 further has an output shaft 551 performing the rotational direction and rotational speed of the motor 10 and synchronously rotates a shaft 51 of the variable resistor 50 so as to change the resistance of the variable resistor 50. An external positioning feedback device receives the resistance and shows a user the current position of the actuator, so as to improve use safety of the actuator.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A linear actuator, comprising:
a motor that has a gearbox for outputting power from a driving shaft of the motor;
a connecting member, having one end affixed to a housing of the gearbox;
a protective tube, connected to an opposite end of the connecting member;
a lead screw, having one end coupled with the gearbox of the motor, a body passing through the connecting member and extending inside the protective tube, and a nut assembled thereto;
an output shaft, having one end coupled with the nut, a body extending inside the protective tube, and an opposite end jutting out from the protective tube; and
a first limit switch and a second limit switch, being contact switches and settled in the protective tube with a predetermined distance therebetween, wherein a contacting portion raised from a surface of the nut is configured to touch contacting portions of triggers of the first limit switch and the second limit switch.

2. The linear actuator of claim 1, further comprising a reduction gear that is assembled to a bottom of the motor to retard the driving shaft of the motor and is connected to a variable resistor.

3. The linear actuator of claim 1, wherein the connecting member and the gearbox are combined together with a packing ring settled therebetween.

4. The linear actuator of claim 3, wherein the packing ring includes a combining portion, a packing portion, a fixing portion and a central channel axially passing through the packing ring, the combining portion being connected to the gearbox, the packing portion being connected with the connecting member, in which at least a screw radially pierces through a wall of the connecting member and pierces into the fixing portion.

5. The linear actuator of claim 4, wherein the fixing portion has a peripheral groove formed at an outer surface of the packing portion.

6. The linear actuator of claim 4, wherein the combining portion is an externally threaded portion to be screwedly coupled with the inner threaded portion of the gearbox.

7. The linear actuator of claim 4, wherein a first receiving portion is axially formed inside the connecting member for receiving the packing portion of the packing ring, and an outer wall of the packing portion of the packing ring is in close fit with an inner wall of the first receiving portion.

8. The linear actuator of claim 1, wherein, a fixing bar is axially settled inside the protective tube and the first limit switch and the second limit switch are fixed to fixing bar.

9. The linear actuator of claim 1, wherein, a wiring box affixed to the connecting member has wire outlets for allowing wires from the limit switches, a power cord and a motor power-supplying wire to pass through, respectively.
